(19) United States
(12) Patent Application Publication
(10) Pub. No.: US 2010/0329779 A1
(43) Pub. Date: Dec. 30, 2010

(54) Composite Structure

(76) Inventor: Johnson Chen, Mercer Island, WA (US)

Correspondence Address: Yen Jung Sung, 21-80 38 St, #C8, Astoria, NY, 11105, US

(21) Appl. No.: 12/577,721

(22) Filed: Oct. 13, 2009

(30) Foreign Application Priority Data
Jun. 25, 2009 (TW) 098211487

(51) Int. Cl. F16B 2/18

(52) U.S. Cl. 403/374.1

(57) ABSTRACT

A composite structure adopted in composite closet, cabinet, combination house, mechanical assembly, wooden interior decoration or other composite furniture is provided. The composite structure includes a first board and a second board. The first board contains at least one male fitting, wherein said male fitting has a fitting head and a locking pin thereof and the radius of said fitting head is larger than the radius of said locking pin. The second board contains at least one groove on the lateral. Said groove has a wedge therein and said wedge has a mounting extending a fork thereon. Said fork has a slot with width smaller than the radius of said fitting head. Wherein said locking pin is located in said slot and then said fitting head is clipped by said fork and a groove base if said male fitting and said wedge is fastened.

### FIELD OF THE INVENTION

The present invention relates to a composite structure, and particularly to the composite structure adopted in composite closet, cabinet, combination house, mechanical assembly, wooden interior decoration or other composite furniture.

### DESCRIPTION OF THE PRIOR ART

Recently, the appliances in our daily life, such as composite closet, cabinet, combination house, mechanical assembly, wooden interior decoration or other composite furniture, are getting more and more diversified to serve as our convenience. Those appliances, may be constructed with various materials, are normally coupled and fastened with screw.

Please refer to FIG. 1, FIG. 1 is schematic diagram of common composite cabinet of prior art. In FIG. 1, the upside of a cabinet 1 is depicted with explosive diagram. As shown in FIG. 1, the upside of the cabinet 1 is composed of three shelves 11, two side panels 12 and a back panel 14. Wherein, the side panel 12 is coupled to the shelf 11 by means of screws 13. However, the fastening and calibration of the screw 13 is time consume. Besides, the thread of the screw 13 may torture and then the cabinet 1 may loose its components if the cabinet 1 is suffered several times of fabrication or disassembling. Thus, to shorten the fabricating time and make the cabinet 1 capable of multi times of fabrication or disassembling is remained a problem needed to be resolved.

### SUMMARY OF THE INVENTION

The primary object of the invention is to save the fabricating and disassembling time. Moreover, present invention may be capable of multi times of fabrication and disassembling without loosing its components.

To achieve the foregoing and other objects, a composite structure adopted in composite closet, cabinet, combination house, mechanical assembly, wooden interior decoration or other composite furniture is provided. The composite structure includes a first board and a second board. The first board contains at least one male fitting, wherein said male fitting has a fitting head and a locking pin thereof and the radius of said fitting head is larger than the radius of said locking pin. The second board contains at least one groove on the lateral. Said groove has a wedge therein and said wedge has a mounting extending a fork thereon. Said fork has a slot with width smaller than the radius of said fitting head. Wherein said locking pin is located in said slot and then said fitting head is clipped by said fork and a groove base if said male fitting and said wedge is fastened.

In the aforementioned composite structure, wherein said fork and said locking pin are tight fit.

In the aforementioned composite structure, wherein the shape of said fitting head is circle-shaped or polygon.

In the aforementioned composite structure, wherein said male fitting further contains a fitting base with radius larger than the radius of said locking pin, and said fitting base protrudes a male thread beneath locking inside said first board. Said fitting base is abutted against the surface of said first board or disposed inside said first board.

In the aforementioned composite structure, wherein said second board further contains at least one groove disposed on each of laterals.

In the aforementioned composite structure, wherein said first board further fixes at least one female fitting on it, said male fitting containing a male thread and said female fitting containing a female thread, said male fitting being coupled with female fitting by means of fastening said male thread and said female thread.

In the aforementioned composite structure, wherein said male fitting further contains a fitting base with cubic shape; said fitting base has two screw holes disposed at two ends respectively.

As described above, the composite structure of present invention may shorten the time of fastening or calibration on screw. And, the composite structure is able to suffer multi times of fabrication or disassembling. Thus, present invention can be adopted in many appliances such as composite closet, cabinet, combination house, mechanical assembly, wooden interior decoration or other composite furniture, etc.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is schematic diagram of common composing cabinet of prior art;

FIG. 2A˜2B are schematic diagrams presenting fabricating procedure of composite structure in present invention;

FIG. 3 is an application diagram of cabinet in present invention;

FIG. 4 is schematic diagram for coupling of male fitting and female fitting;

FIG. 5 is schematic diagram of composite structure in second embodiment of present invention;

FIG. 6A is schematic diagram of male fitting of another embodiment;

FIG. 6B is schematic diagram of male fitting of yet another embodiment;

FIG. 7 is schematic diagram of male fitting of further embodiment.

### DESCRIPTION OF THE PREFERRED EMBODIMENTS

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

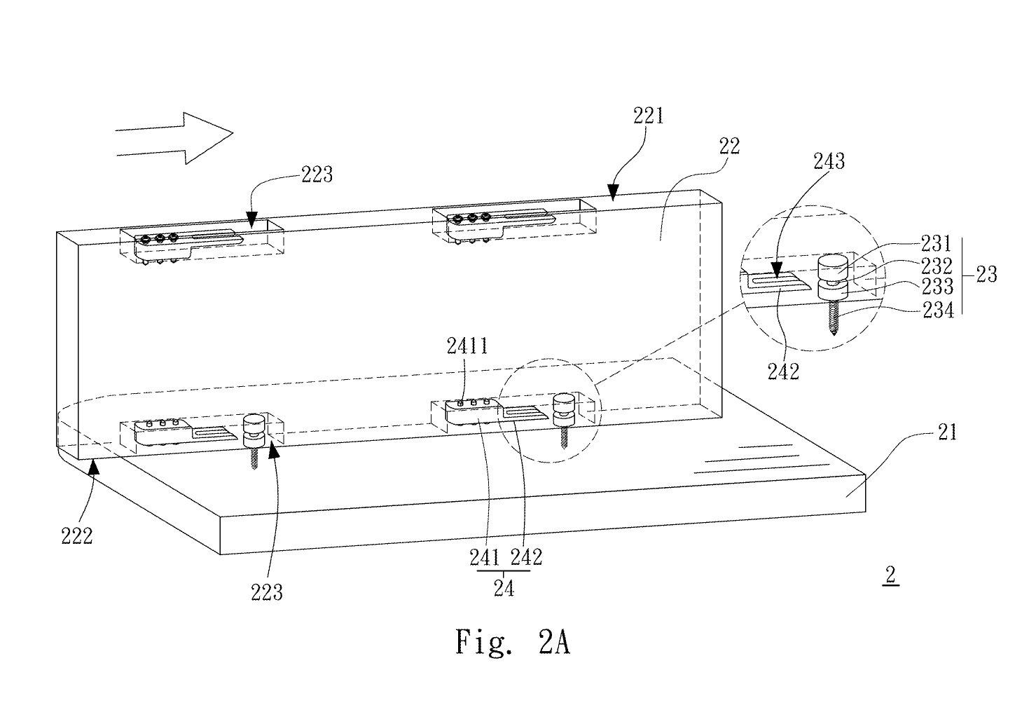

Please refer to FIG. 2A, a composite structure 2 includes a first board 21 and a second board 22. The first board 21 contains two male fitting 23 fixed firmly. The second board 22 contains a first side 221 and a second side 222, and both the first side 221 and second side 222 have two grooves 223 thereon. Each groove 223 has a wedge 24 disposed therein. In this embodiment, the first board 21 and the second board 22 is made of wood, however, they may be replaced with metal or plastic.

Moreover, the male fitting 23 includes a fitting head 231, a locking pin 232, a fitting base 233 and a male thread 234. And, both the radius of the fitting head 231 and of the fitting base 233 are larger than the radius of the locking pin 232. Besides, the wedge 24 has a fork 242 disposed at the front of the wedge 24 and a mounting 241 disposed at the rear of the wedge 24. Wherein, the fork 242 is extended from the mounting 241. The fork 242 has a slot 243 with width smaller than the radius of the fitting head 231. In addition, the fitting base 233 is abutted against the surface of the first board 21 and the male thread 234 is locked beneath the surface of the first board 21.

When the first board 21 and the second board 22 are to fabricate, only to align the groove 223 with the male fitting 23 and then move the second board 22 downward so as to drive the male fitting 23 to enter the groove 223. Afterward, please refer to FIG. 2B, push the second board 22 toward the right in order to urge the locking pin 232 (refer to FIG. 2A simultaneously) to enter the slot 243 of the wedge 24. Since the thickness of the fitting head 231 is approximating to or slightly larger than the distance from the fork 242 to the groove base 2231, the fitting head 231, as the result, is clipped by the fork 242 and the groove base 2231. Thus the second board 22 may be fixed firmly on the first board 21. Furthermore, due to the friction between the fitting head 231 and the fork 242 or the groove base 2231, there must be a larger enough force to push the first board 21 leftward and overcome the friction; if so, the fork 242 may be departed from the fitting head 231 and then the first board 21 may be departed from the second board 22. In this case, when the male fitting 23 is coupled to the wedge 24, the fork 242 and the locking pin 232 are tight fit so as to reinforce the combination between the male fitting 23 and the wedge 24.

In aforementioned description, we may understand the reliability and simplification of the composite structure 2 of present invention. When fabricating the first board 21 and the second board 22, it is only to align the groove 223 with the male fitting 23 so as to make the male fitting 23 locate inside the groove 223, then pushing a horizontal force on the second board 22 to make the male fitting 23 and the wedge 24 be fastened. In the meantime, the fitting head 231 is clipped by the fork 242 and the groove base 2231, and as a result the second board 22 is coupled to the first board 21.

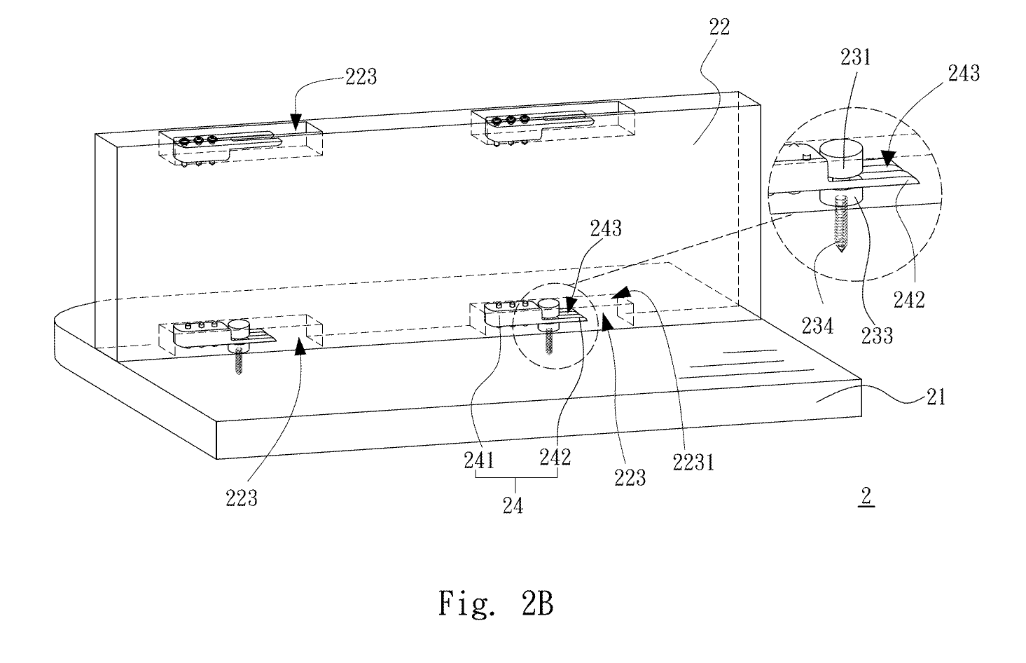

Next, a cabinet will be introduced to show how present invention works and what benefit it may have. Please refer to FIG. 3, FIG. 3 is an application diagram of cabinet in present invention. As shown in FIG. 3, the upside of a cabinet 3 includes three shelves 31, two side panels 32 and a back panel 34 thereof. The side panels 32 contain pluralities of male fittings 23; the shelves 31 and the back panels 34 contain pluralities of grooves 223. Each groove 223 comprises a wedge 24 as shown in FIG. 2A. In FIG. 3, the side panel 32 is corresponded to the first panel 21 in FIG. 2A, and the shelf 31 is corresponded to the second board 22 in FIG. 2A. When fabricating the side panel 32 and the shelf 31, it is only to align the groove 223 with the male fitting 23 so as to make the male fitting 23 locate inside the groove 223, then pushing a horizontal force on the side panel 32 to make the side panel 32 couple to the shelf 31. Additionally, the fabricating procedure of the back panel 34 is similar to those of previous description, thus no need for further addressing.

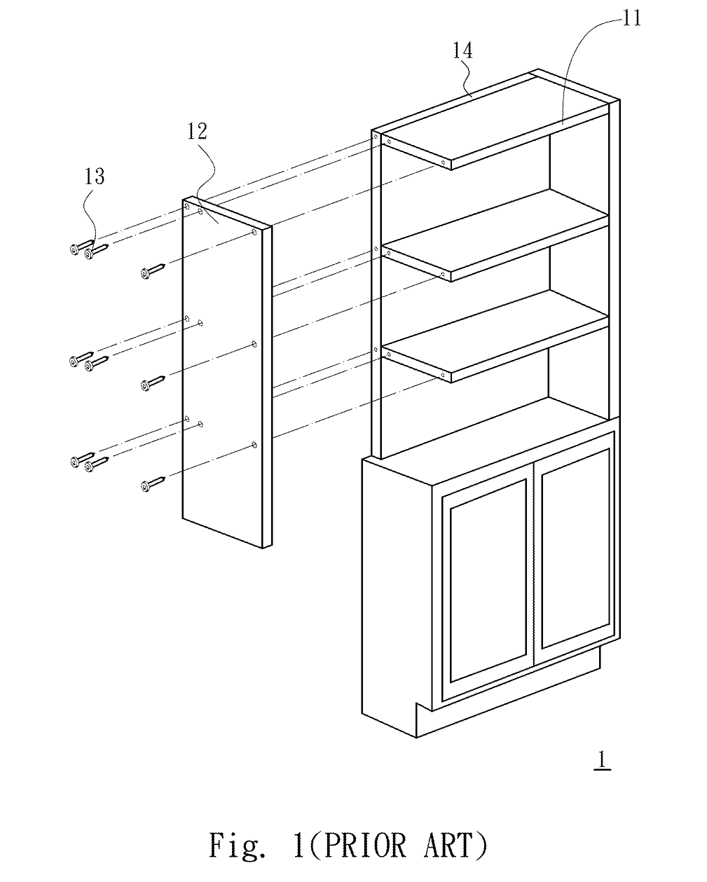

To compare the present invention with screw locking of prior art in FIG. 1, the fabricating time of present invention is obviously reduced. Furthermore, the side panel 32, shelf 31 and the back panel 34 are fabricated without any screw, thus the cabinet 3 may be capable of multi times of fabrication or disassembling without loosing its components.

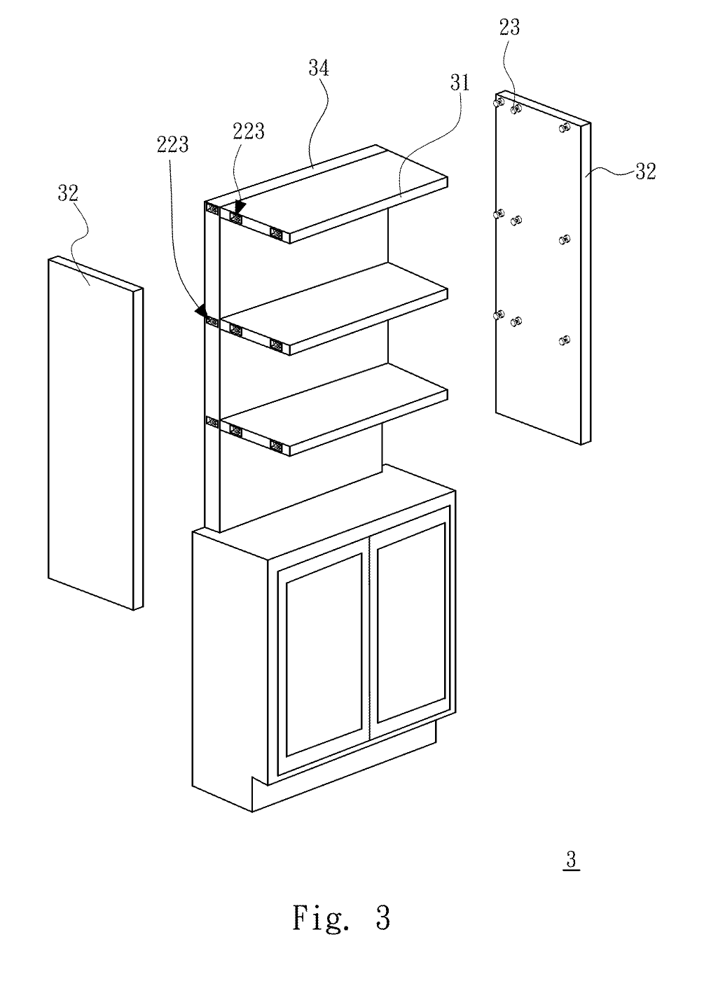

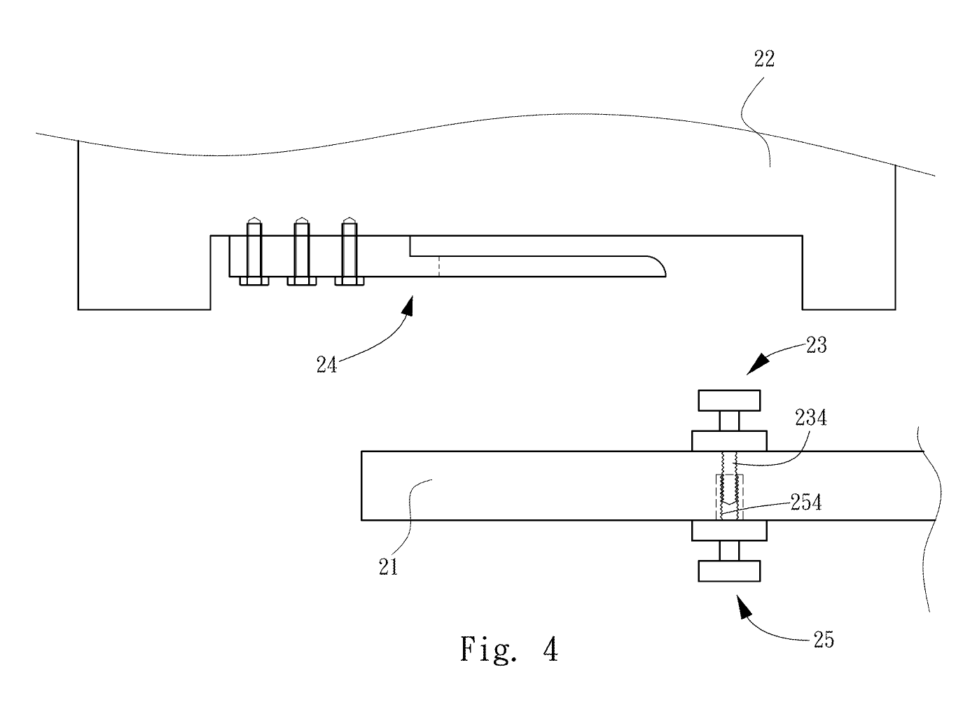

Except that, there is still another configuration. Please refer to FIG. 4, FIG. 4 is schematic diagram for coupling of male fitting and female fitting. As shown in FIG. 4, the first board 21 includes a male fitting 23 and a female fitting 25 disposed at the upside and the underside of the first board 21 respectively. The male fitting 23 and the female fitting 25 have similar configuration; however, the female fitting 25 has a female thread 254 to match up with and fasten the male thread 234 so as to couple the male fitting 23 and the female fitting 25. Afterward, please refer to FIG. 5, FIG. 5 is schematic diagram of composite structure in second embodiment of present invention. As shown in FIG. 5, due to the disposition of the male fitting 23 and the female fitting 25, the first board 21 is able to couple the second boards 22 at the upside and the underside of the first board 21 respectively. In this case, the male fitting 23 and the female fitting 25 are coupled by means of fastening the male thread 234 and the female thread 254.

In practice, each lateral of the second board 22 may dispose more than two grooves 223 in the first side 221 or in the second side 222 which are depicted in FIG. 5, according the span width of the first board 21 and the second board 22; i.e., there is no restriction placed on the number of the groove 223. Correspondingly, the male fitting 23 and the female fitting 25 on the first board 21 are definitely disposed according the number of the grooves 223.

Besides, those skilled in the art may embed the fitting base 233 of the male fitting 23 into the first board 21, i.e., dispose the fitting base 233 inside the first board 21, instead of abutting against the surface of the first board 21 shown in FIG. 2A, in order to reduce the volume of the fitting base 233 exposing outside. Even more, the fitting base 233 may be neglected.

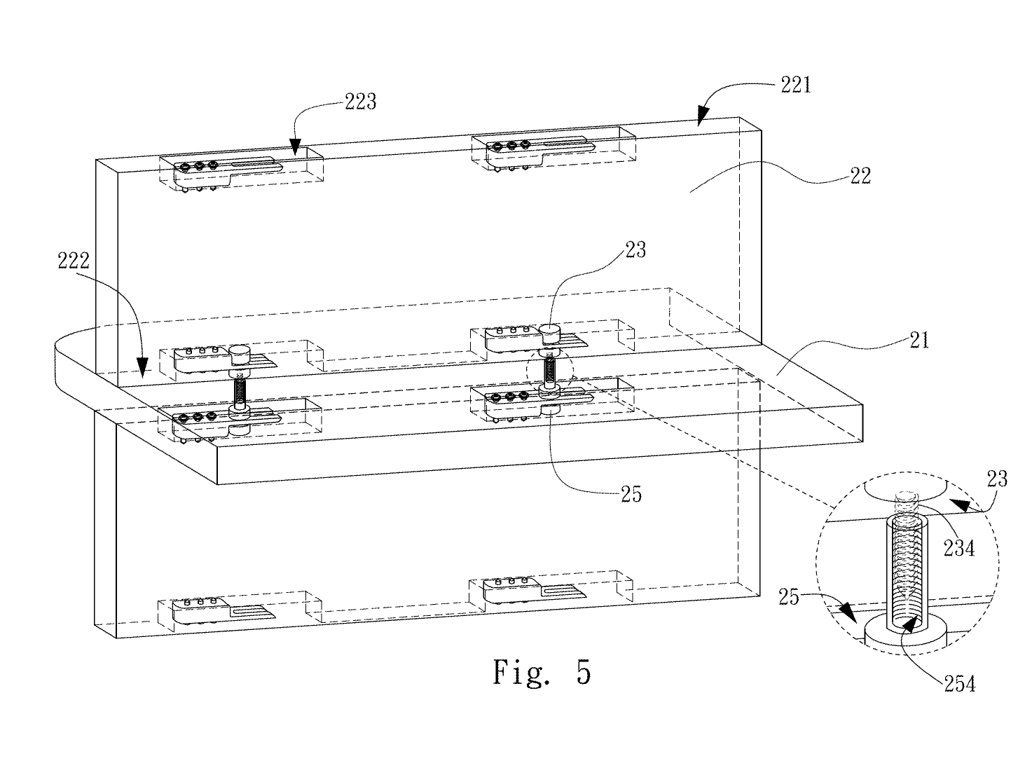

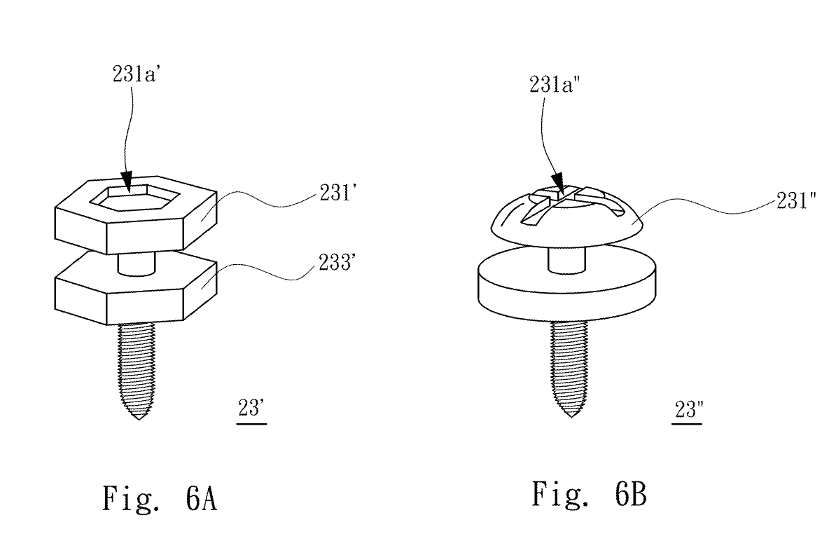

Additionally, compare to the mounting 241 fastening by three screws 2411 shown in FIG. 2A, the screw 2411 may also change its number with one or two screws 2411. As for the configuration of the male fitting 23, the circle-shaped fitting head 231 may be replaced. Please refer to FIG. 6A, the fitting head 231′ and the fitting base 233′ of the male fitting 23′ are hexagon; the hex head 231a′ is specifically for hex wrench. In FIG. 6B, the fitting head 231″ of the male fitting 23″ is cone-shape; the Philips head 231a″ is specifically for screwdriver. Moreover, the female fitting 25 may have similar configuration like fitting head 231′ and fitting base 233′ in male fitting 23′, or fitting head 231″ and fitting base 233″ in male fitting 23″.

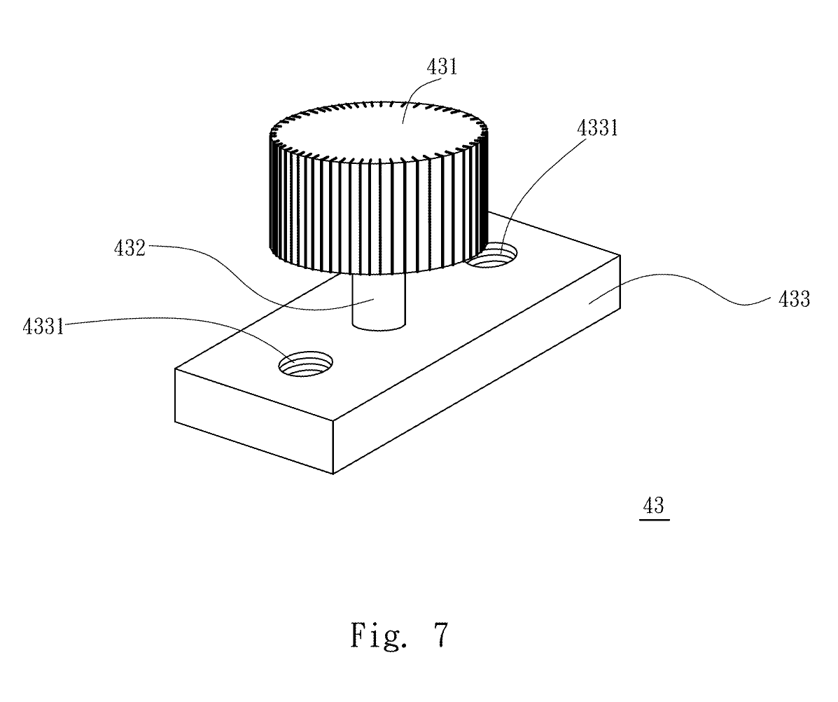

In aforementioned embodiments, the material of the male fitting or the female fitting may be metal, plastic or other materials. Besides, the fitting base 233 in FIG. 2A may be designed with other configuration. Please refer to FIG. 7, FIG. 7 is schematic diagram of male fitting of further embodiment. The male fitting 43 contains a fitting head 431, a locking pin 432 and a fitting base 433. In this embodiment, the male fitting 43 has no male thread 234 as shown in FIG. 2A. Instead, the male fitting 43 has the fitting base 433 with cubic shape, and the fitting base 433 has two screw holes 4331 disposed at two ends of the fitting base 433 respectively. And then the male fitting 43 is able to be firmly fixed on the first board 21 by the screw holes 4331.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

I claim:

1. A composite structure, including:
a first board containing at least one male fitting, wherein said male fitting has a fitting head and a locking pin thereof and the radius of said fitting head is larger than the radius of said locking pin; and
a second board containing at least one groove on the lateral, said groove having a wedge therein and said wedge having a mounting extending a fork thereon, said fork having a slot with width smaller than the radius of said fitting head;
wherein said locking pin is located in said slot and then said fitting head is clipped by said fork and a groove base if said male fitting and said wedge is fastened.

2. The composite structure of claim 1, wherein said fork and said locking pin are tight fit.

3. The composite structure of claim 1, wherein the shape of said fitting head is circle-shaped or polygon.

4. The composite structure of claim 1, wherein said male fitting further contains a fitting base with radius larger than the radius of said locking pin, and said fitting base protrudes a male thread beneath locking inside said first board.

5. The composite structure of claim 4, wherein said fitting base is abutted against the surface of said first board.

6. The composite structure of claim 4, wherein said fitting base is disposed inside said first board.

7. The composite structure of claim 1, wherein said second board further contains at least one groove disposed on each of laterals.

8. The composite structure of claim 1, wherein said first board further fixes at least one female fitting on it, said male fitting containing a male thread and said female fitting containing a female thread, said male fitting being coupled with female fitting by means of fastening said male thread and said female thread.

9. The composite structure of claim 1, wherein said male fitting further contains a fitting base with cubic shape.

10. The composite structure of claim 9, wherein said fitting base has two screw holes disposed at two ends respectively.
